(19) United States
(12) Patent Application Publication
(10) Pub. No.: US 2010/0176029 A1
(43) Pub. Date: Jul. 15, 2010

(54) Upgrading Slurry Oil Using Chromatographic Reactor Systems

(75) Inventors: Ayyappan Subbiah, Bartlesville, OK (US); Tushar V. Choudhary, Bartlesville, OK (US)

Correspondence Address: ConocoPhillips Company - IP Services Group;Attention: DOCKETING, 600 N. Dairy Ashford, Bldg. MA-1135, Houston, TX, 77079, US

(73) Assignee: ConocoPhillips Company, Houston, TX (US)

(21) Appl. No.: 12/351,391

(22) Filed: Jan. 9, 2009

(51) Int. Cl. C10G 25/00; B01J 19/00

(52) U.S. Cl. 208/91; 422/187

(57) ABSTRACT

Methods and apparatus relate to reducing content of nitrogen-containing compounds within slurry oil using a chromatographic based assembly, which may not affect aromatic content, prior to feeding the slurry oil into a coking system. The slurry oil passes through the chromatographic based assembly to upgrade the slurry oil and make the slurry oil suitable for feedstock in making needle coke. Further, a hydrotreater utilized in combination with the chromatographic based assembly may provide additional upgrading of the slurry oil.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

Embodiments of the invention relate to processing hydrocarbon containing mixtures.

### BACKGROUND OF THE INVENTION

Quality of slurry oil used as feedstock to a delayed coking system depends on content of the slurry oil, which also determines quality of needle coke subsequently produced. The needle coke must be of sufficient quality to make graphite electrodes of commercial value. Greater aromatic content and lower sulfur and nitrogen content corresponds to higher quality for the slurry oil.

Hydrotreating the slurry oil in presence of hydrogenating catalyst provides one approach for removing nitrogen from the slurry oil. However, aromatic hydrogenation reactions tend to occur with this hydro-denitrogenation (HDN). Utilizing the HDN to remove nitrogen limits ability to achieve all desired quality criteria for the slurry oil since the HDN results in undesirable lowering of aromatic content in the slurry oil which ultimately affects the quality of the needle coke.

Therefore, a need exists for improved systems and methods of processing hydrocarbon containing mixtures, such as used for needle coke precursor.

### SUMMARY OF THE INVENTION

In one embodiment, a method of producing needle coke includes passing a slurry oil mixture through a chromatographic based assembly to produce upgraded slurry oil. Nitrogen-containing compounds within the slurry oil mixture adsorb onto packing material of the chromatographic based assembly. The method further includes introducing the upgraded slurry oil into a coking system that produces the needle coke.

According to one embodiment, a system for producing needle coke includes a supply for a slurry oil mixture and a chromatographic based assembly having an inlet to receive the slurry oil mixture and an outlet. The chromatographic based assembly includes packing material that is an adsorbent for nitrogen-containing compounds within the slurry oil mixture. A coking system produces the needle coke and has a feedstock supply coupled to the outlet of the chromatographic based assembly such that the packing material of the chromatographic based assembly is disposed in a flow path of the slurry oil mixture between the supply for the slurry oil mixture and the coking system.

For one embodiment, a method of producing needle coke includes removing nitrogen-containing compounds within slurry oil by chromatography. In addition, removing sulfur-containing compounds within the slurry oil occurs by hydro-desulfurization. Coking the slurry oil, which is output from the chromatography and the hydro-desulfurization, produces the needle coke.

### BRIEF DESCRIPTION OF THE DRAWINGS

The invention, together with further advantages thereof, may best be understood by reference to the following description taken in conjunction with the accompanying drawings.

FIG. 1 is a schematic diagram of a system that is for processing slurry oil to produce needle coke and that includes regenerative-chromatographic reactors, according to one embodiment.

FIG. 2 is a schematic diagram of another system that is for processing slurry oil to produce needle coke and that includes a regenerative-chromatographic based assembly coupled with a hydrotreater, according to one embodiment.

### DETAILED DESCRIPTION OF THE INVENTION

Embodiments of the invention relate to reducing content of nitrogen-containing compounds within slurry oil using a chromatographic based assembly, which may not affect aromatic content, prior to feeding the slurry oil into a coking system. The slurry oil passes through the chromatographic based assembly to upgrade the slurry oil and make the slurry oil suitable for feedstock in making needle coke. Further, a hydrotreater utilized in combination with the chromatographic based assembly may provide additional upgrading of the slurry oil.

As used herein, slurry oil refers to a mixture having an API gravity of less than 10°. The slurry oil includes various hydrocarbons including poly-cyclic aromatic rings. In addition to the hydrocarbons, the slurry oil may contain nitrogen, sulfur and other metals, such as copper, iron, nickel, zinc, and vanadium.

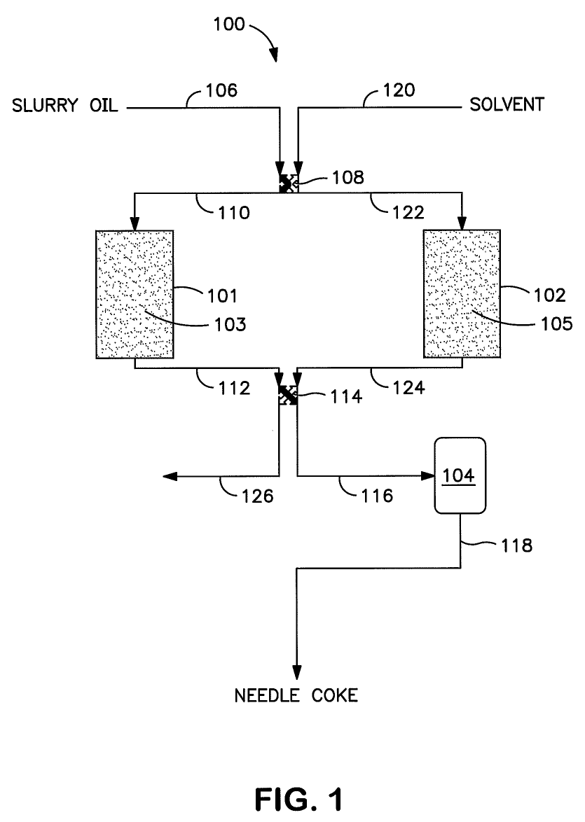

FIG. 1 shows a system 100 for processing slurry oil to produce needle coke. The system 100 includes a chromatographic first reactor 101, a chromatographic second reactor 102, and a coking system 104. The first and second reactors 101, 102 each respectively contain first and second adsorbent packing material 103, 105. As explained herein, the first and second adsorbent packing material 103, 105 can be the same material.

A slurry oil supply conduit 106 contains the slurry oil that may be produced in a refinery. The supply conduit 106 couples to a flow control device such as a first valve 108 operable to divert flow from the supply conduit 106 to either the first reactor 101 or the second reactor 102 based on an operational state of the system 100. Selective operation of the first valve 108 as shown illustrates the system 100 in a first reactor online state with the second reactor 102 being regenerated.

While only one of the reactors 101, 102 is needed in some embodiments for batch processing of the slurry oil, the system 100 may utilize the first and second reactors 101, 102 in a swing arrangement as described further herein. This operation of the first and second reactors 101, 102 within the system 100 both accommodates continuous intake of the slurry oil from the supply conduit 106 without need for slurry oil storage tanks and provides, without need for additional storage tanks, continuous output to the coking system 104 to avoid interrupting coking operations. For some embodiments, the system 100 may include further chromatographic reactors in addition to the first and second reactors 101, 102 for greater throughput, to ensure sufficient time for regeneration, or for ability to maintenance any one reactor while still being able to switch among a remaining two or more reactors.

In the first reactor online state, the slurry oil delivered from the refinery via the supply conduit 106 passes through the first valve 108 to a first reactor inlet 110. The first reactor inlet 110 introduces the slurry oil into an interior volume of the first reactor 101. A flow path of the slurry oil through the first reactor 101 extends between the first reactor inlet 110 and a first reactor outlet 112. Since the first packing material 103 is disposed in the flow path, the slurry oil contacts the first packing material 103 within the first reactor 101.

The first packing material 103 retains polar compounds such as nitrogen-containing compounds and sulfur-containing compounds. The nitrogen-containing compounds and the and sulfur-containing compounds within the slurry oil adsorb onto the first packing material 103 while hydrocarbons that are non-polar pass through the first reactor 101. The first reactor 101 thereby functions to remove the nitrogen-containing compounds from the slurry oil. For some embodiments, solid particles of a polar compound form the first packing material 103 and may have a spherical shape. Examples of the first packing material 103 include silica (100% SiO₂) and modified forms of silica, such as silica gel or silica modified with a metal (e.g., aluminum), a metal oxide (e.g., alumina, titania), an acid (e.g., hydrochloric acid), a base (e.g., potassium hydroxide), or an organic compound (e.g., octadecylsilyl). While described with reference to the first packing material 103, the second packing material 105 and the first packing material 103 may be alike.

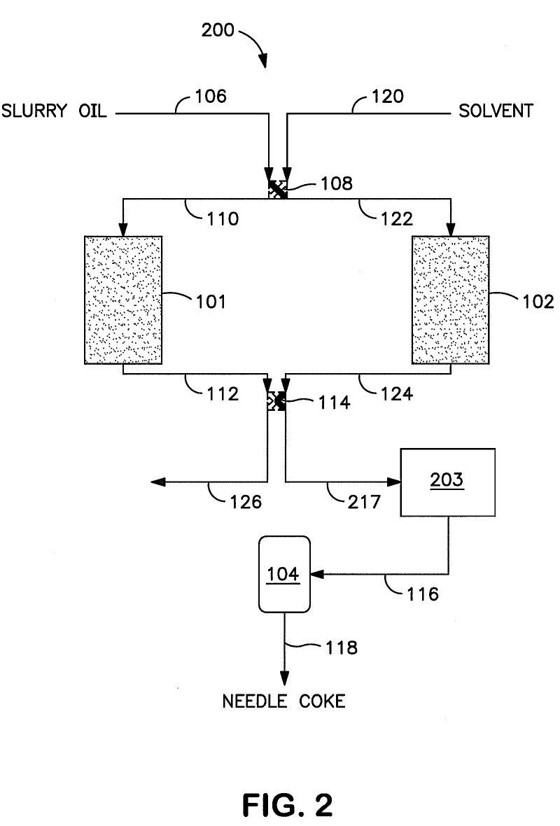

Even though not all the nitrogen-containing compounds and the sulfur-containing compounds may be removed from the slurry oil upon the slurry oil passing through the first reactor 101, the first reactor 101 upgrades the slurry oil such that weight percent of the nitrogen-containing compounds in the slurry oil at the first reactor outlet 112 is reduced relative to weight percent of the nitrogen-containing compounds in the slurry oil at the first reactor inlet 110. For some embodiments, the first reactor 101 may provide at least a 20% reduction of the nitrogen-containing compounds in the slurry oil. Sensing nitrogen content of the slurry oil before and after the slurry oil passes through the first reactor 101 enables determining amount of the reduction. Further, set thresholds (e.g., less than 25%) for this amount of reduction or a specified time interval may trigger switching from the first reactor online state to a second reactor online state. In the second reactor online state (see, FIG. 2), the first valve 108 directs the slurry oil from the supply conduit 106 to the second reactor 102 while the first reactor 101 is regenerated.

While still in the first reactor online state, another flow control device such as a second valve 114 directs flow of the slurry oil from the first reactor outlet 112 to a feedstock supply 116 for the coking system 104. For some embodiments, the coking system 104 may include conventional components, such as furnaces and drums, for performing coking operations. The coking operation produces the needle coke output from the coking system 104, as indicated by needle coke transport route 118. Preparing of graphite electrodes suitable for use in metallurgical industries further occurs in some embodiments upon making the needle coke in the coking system 104.

As an example of the coking operation performed by the coking system 104, a coking furnace heats the slurry oil from the feedstock supply 116 prior to the slurry oil being introduced into a coke drum. During the coking operation, the slurry oil thermally decomposes into vapor products and solid needle coke that is left behind in the coke drum. The coking processes may function in a swing manner such that while one coke drum is being filled another one is being purged of the vapors, cooled, opened for removal of the solid needle coke, and readied for refilling.

With respect to aforementioned regeneration of the second reactor 102, the first valve 108 directs a polar solvent within a solvent conduit 120 to a second reactor inlet 122. Exemplary solvents include polar protic solvents, such as methanol, ethanol, n-propanol or iso-propanol, or polar aprotic solvents, such as acetone, acetonitrile, di-methyl formamide (DMF) or di-methyl sulfoxide (DMSO). The solvent contacts the second packing material 105 (and/or the first packing material 103 if regenerating the first reactor 101) and desorbs the nitrogen-containing compounds adsorbed from the slurry oil passing through the second reactor 102 during operation of the system 100 in the second reactor online state. Then, the solvent exits the second reactor 102 via a second reactor outlet 124. The second valve 114 directs flow of the solvent from the second reactor outlet 124 to a solvent waste stream 126, while the system is in the first reactor online state. Once the nitrogen-containing compounds are desorbed using the solvent and flushed from the second reactor 102, the second packing material 105 is regenerated such that the second packing material 105 is again able to adsorb the nitrogen-containing compounds in the slurry oil when the system 100 is switched back to the second reactor online state.

Volumes of the first and second reactors 101, 102 may depend on desired residence time of the slurry oil given a particular flow rate of the slurry oil. Longer residence times may facilitate greater adsorption and removal of the nitrogen-containing compounds. In some embodiments, the first and second reactors 101, 102 may operate under different conditions at different times. For example, temperature within the first and second reactors 101, 102 may be at ambient temperature (e.g., between 15° C. and 30° C.) when adsorbing the nitrogen-containing compounds from the slurry oil and may be increased (e.g., at least 10° C. higher relative to when adsorbing) to facilitate desorption when desorbing the nitrogen-containing compounds using the solvent. For some embodiments, pressures within the first and second reactors 101, 102 may be between 0 pounds per square inch gauge (psig) and 200 psig.

Actuation of the first and second valves 108, 114 switches the system 100 between the first reactor online state and the second reactor online state. The swing arrangement cycles to alternate between the states during operation. This cycling alternates between placing the first reactor 101 in fluid communication with the slurry oil and coking system 104 and placing the first reactor 101 in fluid communication with the solvent and the solvent waste stream 126. Likewise, the cycling alternates between placing the second reactor 102 in fluid communication with the slurry oil and coking system 104 and placing the second reactor 102 in fluid communication with the solvent and the solvent waste stream 126. Further, placing the second reactor 102 in fluid communication with the slurry oil and coking system 104 may occur at different times than placing the first reactor 101 in fluid communication with the slurry oil and coking system 104. While respective flow paths change between the states, operational details of the second reactor online state correspond with operational details of the first reactor online state to provide continuous upgrading of the slurry oil used as precursor for the needle coke.

FIG. 2 illustrates a serial staged system 200 for processing slurry oil to produce needle coke. The system 200 includes various analogous components and features shown in FIG. 1 and identified by common reference numbers. Any aspects set forth herein for an element identified by a given reference number apply to corresponding elements having the common reference number. The system 200 includes a chromatographic based assembly (e.g., the chromatographic first reactor 101 and the chromatographic second reactor 102) coupled in series with a hydrotreater 203 in order to remove nitrogen-containing compounds and sulfur-containing compounds from the slurry oil prior to feeding the slurry oil to the coking system 104.

By contrast to FIG. 1 showing the first reactor online state, FIG. 2 depicts the first and second valves 108, 114 operated to place the system 200 in the second reactor online state. In the second reactor online state, the second reactor 102 is in fluid communication with slurry oil and the coking system 104 via the supply conduit 106, the second reactor inlet 122, the second reactor outlet 124, a hydrotreater inlet 217, the hydrotreater 203 and the feedstock supply 116. Further, regeneration of the first reactor 101 occurs during the second reactor online state by the first reactor 101 being in fluid communication with the solvent and the solvent waste stream 126 via the solvent conduit 120, the first reactor inlet 110, and the first reactor outlet 112.

The hydrotreater 203 further removes sulfur from the slurry oil through hydro-desulfurization (HDS). Unlike the first and second reactors 101, 102 that provide separation without chemical reaction of the slurry oil, the hydrotreater 203 relies on catalyzed hydrogenation chemical reactions of the slurry oil to hydrogenate the sulfur-containing compounds within the slurry oil. A hydrogen-containing gas within the hydrotreater 203 supplies hydrogen for the chemical reaction. The HDS converts the sulfur-containing compounds within the slurry oil into organic products and hydrogen sulfide, which can be stripped from the slurry oil that includes the organic products and is less volatile than the hydrogen sulfide. The catalyst selected for use in the hydrotreater 203 can be sulfur-specific since the first and second reactors 101, 102 reduce content of the nitrogen-containing compounds in the slurry oil independent of any hydrotreating of the slurry oil. For some embodiments, the hydrotreater 203 may include catalyst formed of small clusters of molybdenum disulfide with cobalt or nickel additives that serve to promote the chemical reaction.

The nitrogen-containing compounds in the slurry oil tend to inhibit sulfur removal during the HDS. Performing the HDS after passing the slurry oil through one of the first and second reactors 101, 102 can thus benefit from removal of some of the nitrogen-containing compounds in the slurry oil. Use of the first and second reactors 101, 102 for chromatography ahead of the hydrotreater 203 thereby enables operation of the hydrotreater 203 without heating to as high of temperatures compared to temperatures needed for the HDS without the removal of any of the nitrogen-containing compounds in the slurry oil. The slurry oil may be maintained at low enough pressures and temperatures within the hydrotreater 203 to limit or prevent saturation of aromatics in the slurry oil. For example, the hydrotreater 203 may heat to less than 375° C.

The preferred embodiment of the present invention has been disclosed and illustrated. However, the invention is intended to be as broad as defined in the claims below. Those skilled in the art may be able to study the preferred embodiments and identify other ways to practice the invention that are not exactly as described in the present invention. It is the intent of the inventors that variations and equivalents of the invention are within the scope of the claims below and the description, abstract and drawings not to be used to limit the scope of the invention.

1. A method of producing needle coke products, comprising:
passing a slurry oil mixture through a chromatographic based assembly to produce upgraded slurry oil, wherein nitrogen-containing compounds within the slurry oil mixture are adsorbed onto packing material of the chromatographic based assembly without affecting aromatic content of the slurry oil mixture; and
introducing the upgraded slurry oil into a coking system to make needle coke.

2. The method according to claim 1, further comprising reacting the upgraded slurry oil in presence of a catalyst to hydrogenate sulfur-containing compounds in the upgraded slurry oil.

3. The method according to claim 1, further comprising hydrotreating the upgraded slurry oil, wherein the hydrotreating generates hydrogen sulfide from sulfur-containing compounds in the upgraded slurry oil and strips the hydrogen sulfide from the upgraded slurry oil.

4. The method according to claim 1, wherein the nitrogen-containing compounds within the slurry oil mixture adsorb onto silica that forms the packing material.

5. The method according to claim 1, wherein the nitrogen-containing compounds within the slurry oil mixture adsorb onto modified silica that forms the packing material.

6. The method according to claim 1, wherein passing the slurry oil mixture through the chromatographic based assembly includes alternating between flowing the slurry oil mixture through a chromatographic first reactor and flowing the slurry oil mixture through a chromatographic second reactor.

7. The method according to claim 1, further comprising regenerating the packing material by passing a solvent through the chromatographic based assembly.

8. The method according to claim 1, further comprising regenerating the packing material by alternating between flowing a solvent through a chromatographic first reactor and flowing the solvent through a chromatographic second reactor, wherein passing the slurry oil mixture through the chromatographic based assembly alternates between flowing the slurry oil mixture through the first reactor and flowing the slurry oil mixture through the second reactor.

9. A system for producing needle coke products, comprising:
a supply for a slurry oil mixture;
a chromatographic based assembly having an inlet to receive the slurry oil mixture and an outlet, wherein the chromatographic based assembly includes packing material that is an adsorbent for nitrogen-containing compounds within the slurry oil mixture; and
a coking system configured to make needle coke, wherein a feedstock supply for the coking system is coupled to the outlet of the chromatographic based assembly such that the packing material of the chromatographic based assembly is disposed in a flow path of the slurry oil mixture between the supply for the slurry oil mixture and the coking system.

10. The system according to claim 9, further comprising a hydrotreater, wherein the flow path of the slurry oil mixture passes through the hydrotreater between the supply for the slurry oil mixture and the coking system.

11. The system according to claim 9, further comprising a hydrotreater, wherein the flow path of the slurry oil mixture passes through the hydrotreater between the chromatographic based assembly and the coking system.

12. The system according to claim 9, further comprising a hydrotreater having a catalyst of a reaction that hydrogenates sulfur-containing compounds in the slurry oil mixture, wherein the flow path of the slurry oil mixture passes through the hydrotreater.

13. The system according to claim 9, wherein the chromatographic based assembly includes first and second reactors each filled with the packing material.

14. The system according to claim 9, wherein the chromatographic based assembly includes first and second reactors each filled with the packing material and in alternate fluid communication with the supply for the slurry oil mixture and a solvent source.

15. The system according to claim 9, wherein the packing material comprises silica.

16. The system according to claim 9, wherein the packing material comprises modified silica.

17. A method of producing needle coke products, comprising:
removing nitrogen-containing compounds within a slurry oil by chromatography;
removing sulfur-containing compounds within the slurry oil by hydro-desulfurization; and
coking the slurry oil, which is output from the chromatography and the hydro-desulfurization, to make needle coke solids.

18. The method according to claim 17, wherein the chromatography occurs in multiple reactors operated in a cycle such that certain one or more of the reactors are regenerated by solvent washing while another one or more of the reactors are removing the nitrogen-containing compounds.

19. The method according to claim 17, wherein the chromatography reduces weight percent of the nitrogen-containing compounds in the slurry oil by at least 20%.

20. The method according to claim 17, further comprising preparing graphite electrodes with the needle coke solids.
